(19) United States
(12) Patent Application Publication
(10) Pub. No.: US 2021/0116322 A1
(43) Pub. Date: Apr. 22, 2021

(54) MONITORING TECHNIQUES FOR PRESSURIZED SYSTEMS

(71) Applicant: Everactive, Inc., Santa Clara, CA (US)

(72) Inventors: Todd Klanderud, Wayne, MI (US); Shadi Hawawini, Mountain View, CA (US); David D. Wentzloff, Ann Arbor, MI (US)

(21) Appl. No.: 16/654,949

(22) Filed: Oct. 16, 2019

(51) Int. Cl. G01M 3/00; F16K 37/00

(52) U.S. Cl. CPC G01M 3/002; F16K 37/00

(57) ABSTRACT

Methods and apparatus are described that relate to the monitoring of various types of components in pressurized systems. These may include batteryless monitors that run on power harvested from their environments, systems for acquiring monitor data for the components of a pressurized system, and/or techniques for processing monitor data to determine the status of the components and/or the system.

### BACKGROUND

Pressurized systems are used in a wide variety of industrial applications as delivery and/or removal systems for gases and liquids. Pressurized systems may also be used to provide energy. For example, steam systems provide energy via heat transfer, e.g., steam generated by a boiler flows through a distribution system to heat exchangers by which the heat of the steam is transferred to loads. Pressurized systems typically include components designed to improve safety and reliability by reducing pressure and/or removing undesirable byproducts (e.g., condensates in steam systems). Such components include, for example, safety valves, pressure relief valves, rupture discs, steam traps, etc.

While such components are highly effective in preventing catastrophic system failures that can result from over-pressure conditions, it may not be immediately apparent when a given component is operating to relieve system pressure. This can result in reduced system efficiency and difficult troubleshooting. In addition, these components themselves are characterized by failure modes which can prevent them from performing their intended function. However, particularly for large installations, manual inspection and maintenance of these components may not be particularly effective.

Electronic monitors have been developed for monitoring steam traps in steam systems. However, most steam trap monitors on the market today have issues both with the reliability with which they detect fault conditions, and the fact that most are battery powered and therefore require periodic battery inspection and/or replacement. This, at least partially, defeats the purpose for which these monitors are installed. In addition, given the cost of installing and maintaining these monitors, it is not currently practicable to extend their use to the myriad other types of safety components that are typically included in a pressurized system.

### SUMMARY

According to various implementations, methods, apparatus, devices, systems, and computer program products are provided for monitoring pressurized systems.

According to a particular class of implementations, monitor data are received that are generated by a monitor associated with a component of a pressurized system. The component has an inlet and an outlet. The monitor is configured to capture measurements of a first temperature associated with one of the inlet of the component or the outlet of the component, but not to monitor a second temperature associated with the other of the inlet or the outlet of the component. First time series data are derived from the monitor data. The first time series data represent the first temperature. A state of the component is determined based on the first time series data and without reference to the second temperature.

According to a specific implementation of this class, the first temperature corresponds to a first location along a circumference of a conduit connected to the one of the inlet or the outlet of the component with which the first temperature is associated, and the monitor is also configured to capture measurements of a third temperature associated with the one of the inlet or the outlet of the component with which the first temperature is associated. The third temperature corresponds to a second location along the circumference of the conduit and displaced from the first location. Second time series data are derived from the monitor data. The second time series data represent the third temperature. The state of the component is also determined based on the second time series data. According to a more specific implementation, the second location is displaced from the first location along the circumference of the conduit by about 180 degrees. According to another more specific implementation, the first location is on a top of the conduit relative to a local gravity vector, and the second location is on a bottom of the conduit relative to the local gravity vector.

According to another specific implementation of this class, the state of the component is determined based on the first time series data by determining a rate of change of the first temperature based on the first time series data, and determining that the rate of change corresponds to the state of the component.

According to a more specific implementation, the state of the component is an open state or a leaking state, and determining that the rate of change corresponds to the state of the component includes determining that the rate of change corresponds to the open state or the leaking state.

According to another specific implementation of this class, the state of the component is determined based on the first time series data by determining that first temperature exceeds a threshold. According to a more specific implementation, the state of the component is determined based on the first time series data by determining that first temperature exceeds the threshold within a first duration or for longer than a second duration.

According to another specific implementation of this class, the monitor is also configured to capture measurements of an ambient temperature of the pressurized system in a vicinity of the component. Second time series data are derived from the monitor data. The second time series data represent the ambient temperature, and the state of the component is also determined based on the second time series data. According to a more specific implementation, the state of the component is determined based on the first time series data and the second time series data by comparing a change in the first temperature with a change in the ambient temperature.

According to another class of implementations, monitor data are received that are generated by a monitor associated with a conduit of a pressurized system. The monitor is configured to capture measurements of first and second temperatures associated with the conduit. The first temperature corresponds to a first location on the conduit and the second temperature corresponds to a second location on the conduit displaced from the first location. First time series data are derived from the monitor data. The first time series data represent the first temperature. Second time series data are derived from the monitor data. The second time series data represent the second temperature. A state of the pressurized system is determined based on the first time series data and the second time series data.

According to a specific implementation of this class, the first location is along a circumference of the conduit, and the second location is also along the circumference of the conduit. According to a more specific implementation, the second location is displaced from the first location along the circumference of the conduit by about 180 degrees. According to another more specific implementation, the first location is on a top of the conduit relative to a local gravity vector, and the second location is on a bottom of the conduit relative to the local gravity vector.

According to another specific implementation of this class, the first location and the second location are separated along a longitudinal axis of the conduit.

According to another specific implementation of this class, the monitor is also configured to capture measurements of an ambient temperature of the pressurized system in a vicinity of the conduit. Third time series data are derived from the monitor data. The third time series data represent the ambient temperature. The state of the pressurized system is also determined based on the third time series data. According to a more specific implementation, the state of the pressurized system is determined based on the first, second, and third time series data by comparing a change in one or both of the first and second temperatures with a change in the ambient temperature.

According to another specific implementation of this class, the state of the pressurized system represents one or more of presence of a medium in the conduit, presence of media in the conduit, relative proportions of media in the conduit, a state of a system component, a state of a portion of the pressurized system, or a state of the pressurized system as a whole.

According to another specific implementation of this class, the monitor is also associated with a component of the pressurized system. The component has an inlet and an outlet. The conduit is connected to one of the inlet of the component or the outlet of the component. The first and second temperatures are both associated with the one of the inlet or the outlet of the component to which the conduit is connected, and the monitor is not configured to monitor a third temperature associated with the other of the inlet or the outlet of the component. Determining the state of the pressurized system includes determining a state of the component based on the first and second time series data and without reference to the third temperature.

According to another specific implementation of this class, determining the state of the pressurized system includes one or more of determining a rate of change of the first temperature, determining a rate of change of the second temperature, determining that first temperature exceeds a threshold, or determining that the second temperature exceeds a threshold.

A further understanding of the nature and advantages of various implementations may be realized by reference to the remaining portions of the specification and the drawings.

### BRIEF DESCRIPTION OF THE DRAWINGS

FIG. 1 depicts an example of a pressurized system and a cloud-connected monitoring system enabled by the present disclosure.

FIG. 2 is a block diagram of a monitor enabled by the present disclosure.

FIG. 3 is a flowchart illustrating operation of a particular class of implementations enabled by the present disclosure.

FIGS. 4-6 are graphs of sensor data illustrating particular types of pressure system component behavior.

### DETAILED DESCRIPTION

Reference will now be made in detail to specific implementations. Examples of these implementations are illustrated in the accompanying drawings. It should be noted that these examples are described for illustrative purposes and are not intended to limit the scope of this disclosure. Rather, alternatives, modifications, and equivalents of the described implementations are included within the scope of this disclosure as defined by the appended claims. In addition, specific details may be provided in order to promote a thorough understanding of the described implementations. Some implementations within the scope of this disclosure may be practiced without some or all of these details. Further, well known features may not have been described in detail for the sake of clarity.

The present disclosure describes various devices, systems, and techniques relating to the monitoring of various types of components in a pressurized system. These devices, systems, and techniques include battery-less monitors that run on power harvested from their environments, systems for acquiring monitor data for the components of a pressurized system in a facility (or across multiple facilities), and/or techniques for processing monitor data to reliably determine the status of individual components and potentially other system parameters. It should be noted that the described examples may be used in various combinations. It should also be noted that at least some of the examples described herein may be implemented independently of the others. For example, the techniques described herein for processing monitor data may be employed to process data captured using any of a wide variety of monitors including, but not limited to, the monitors described herein. Similarly, the monitors described herein may be used with any of a wide variety of monitoring systems and data processing techniques including, but not limited to, the systems and techniques described herein.

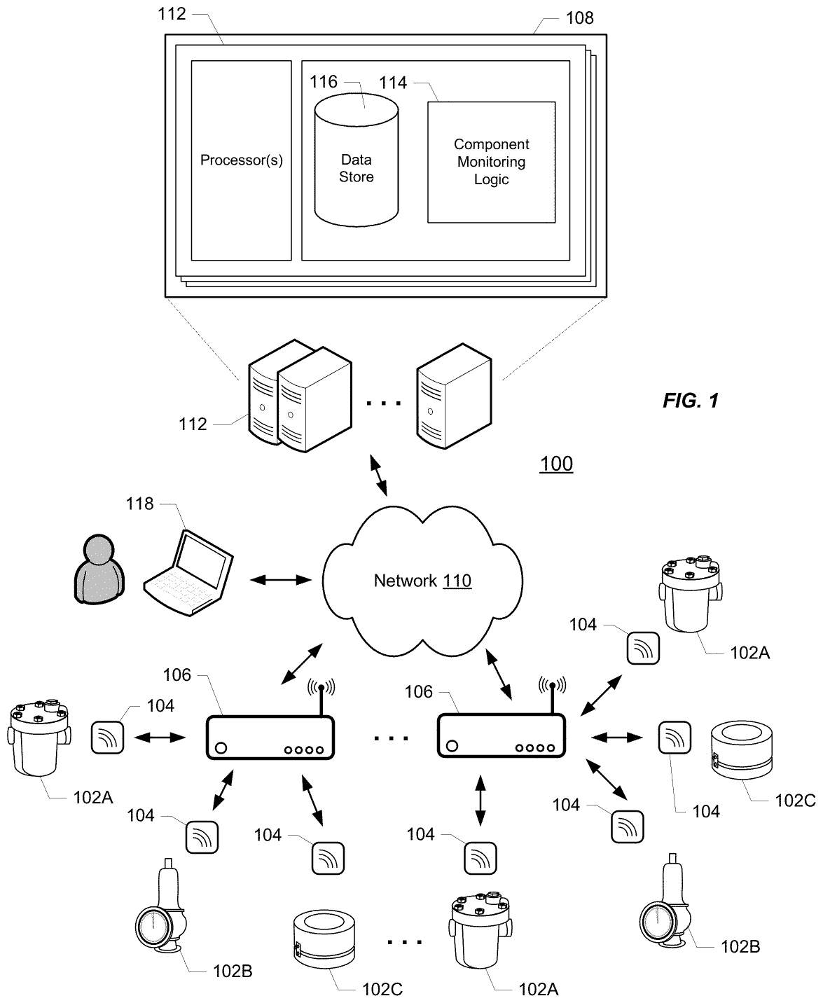

FIG. 1 depicts a monitoring system 100 in which various types of pressurized system components, e.g., steam traps 102A, safety valves 102B, and rupture discs 102C, (potentially hundreds or even thousands of such components) are deployed throughout a facility that employs a steam system. The details of the steam system are not shown for reasons of clarity. Moreover, it should be noted that the steam system of FIG. 1 is merely an example of a pressurized system that may be implemented using the techniques described herein. In addition, the pressurized system components in FIG. 1 are depicted as particular types of components (e.g., steam trap 102A is shown as an inverted bucket steam trap). However, it should be noted that the depicted components are merely examples of some of the types of components that may be monitored as described herein. That is, the systems, monitors, and techniques described herein may be used with any of a variety of devices and components including, for example, pressure relief valves, safety relief valves, rupture discs, control valves, pressure reducing valves, steam traps, and the like, without departing from the scope of this disclosure.

Each component 102 has an associated monitor 104 mounted on or near the component. Monitors 104 generate various types of sensor data relating to the associated component 102 and/or its adjacent piping. Monitors 104 transmit the sensor data to control nodes 106 that, in turn, transmit the sensor data to a monitor data service 108 via network 110. As will be appreciated, the number of monitors 104 and control nodes 106 will vary depending on the facility.

Monitor service 108 may conform to any of a wide variety of architectures such as, for example, a services platform deployed at one or more co-locations, each implemented with one or more servers 112. Monitor service 108 may also be partially or entirely implemented using cloud-based computing resources. Network 110 represents any subset or combination of a wide variety of network environments including, for example, TCP/UDP over IP-based networks, unicast/multicast/broadcast networks, telecommunications networks, wireless networks, satellite networks, cable networks, public networks, private networks, wide area networks, local area networks, the Internet, the World Wide Web, intranets, extranets, and so on.

At least some of the examples described herein contemplate implementations based on computing models that enable ubiquitous, convenient, on-demand network access to a pool of computing resources (e.g., cloud-based networks, servers, storage, applications, and services). As will be understood, such computing resources may be integrated with and/or under the control of the same entity controlling monitor data service 108. Alternatively, such resources may be independent of service 108, e.g., on a platform under control of a separate provider of computing resources with which service 108 connects to consume computing resources as needed, e.g., a cloud-computing platform or service.

It should also be noted that, despite any references to particular computing paradigms and software tools herein, the computer program instructions on which various implementations are based may correspond to any of a wide variety of programming languages, software tools and data formats, may be stored in any type of non-transitory computer-readable storage media or memory device(s), and may be executed according to a variety of computing models including, for example, a client/server model, a peer-to-peer model, on a stand-alone computing device, or according to a distributed computing model in which various functionalities may be effected or employed at different locations.

Monitors 104 may communicate with control nodes 106 using any of a wide variety of wired and wireless protocols and technologies. According to some implementations, control nodes 106 and monitors 104 communicate using a proprietary low-power communication protocol known as Evernet™ provided by Everactive™, Inc., of Santa Clara, Calif. Examples of such protocols and associated circuitry suitable for use with such implementations are described in U.S. Pat. Nos. 9,020,456 and 9,413,403, and U.S. Patent Publications No. 2014/0269563 and No. 2016/0037486, the entire disclosure of each of which is incorporated herein by reference for all purposes. However, it should be noted that implementations are contemplated in which other modes of communication between the monitors and the rest of the system are employed.

Control nodes 106 may be implemented using any of a variety of suitable industrial Internet gateways, and may connect to monitor service 108 using any of a variety of wired and wireless protocols, e.g., various versions of Ethernet, various cellular (e.g., 3G, LTE, 5G, etc.), various wi-fi (802.11b/g/n, etc.), etc. In some cases, otherwise conventional gateways are augmented to include components that implement the Evernet™ protocol.

Each monitor 104 generates sensor data representing one or more temperatures associated with the component with which it is associated, and possibly other sensed data associated with the component. Temperature measurements may be captured using one or more temperature sensors (e.g., thermistors) connected to the piping at the inlet side and/or the outlet side of the component. The monitors may also be configured to capture and generate sensor data representing ambient temperature and/or humidity of the environment in which the monitor is deployed.

Each monitor 104 may also be configured to generate sensor data representing a variety of other parameters generated by a variety of sensor types and/or sources. For example, a monitor might measure and/or track light levels, humidity, vibrational or other types of mechanical energy, acoustic energy, ultrasonic energy, etc.

According to a particular implementation, in response to a wakeup message from its control node 106 or a local wakeup timer, each monitor 104 transitions from a low-power mode, takes readings on each of its sensors, and transmits digitized versions of the readings to its control node 106 in a packet in which each sensor and its reading are paired (e.g., as a label-value pair). The packet also includes information (e.g., in a header) that identifies the specific monitor with a unique identifier and the timestamp of the readings in the packet. The wakeup messages may be periodically transmitted from each control node to its associated monitors. In this way, each monitor 104 “continuously” monitors the component with which it is associated.

Each control node 106 stores the packets received from its monitors 104 in local memory, and periodically or opportunistically uploads the stored information to monitor data service 108 (e.g., to a cloud-based service when the control node is connected to the Internet). Thus, if there is an outage, the control node is able to cache the sensor data until the connection is restored. At least some of the processing of the sensor data may be done by monitor data service 108, e.g., using logic 114. However, it should be noted that implementations are contemplated in which at least some of the processing of the data generated by monitors 104 may be performed elsewhere, e.g., by monitors 104 and/or by control nodes 106. Monitor data service 108 may also store historical data for monitoring system 100 (e.g., in data store 116). The monitor data and other system data generated and/or received by monitor data service 108 and stored in data store 116 may be accessed on demand (e.g., in a dashboard on computing device 118) by responsible personnel associated with the facility or facilities in which the steam trap monitoring system is deployed.

Some techniques for determining the state of a component in a pressurized system rely on measurement of the temperatures on both the inlet and outlet sides of the component. However, such techniques require either two monitors or, if a single monitor is used, wiring that runs across the component. As will be appreciated by those of skill in the art, while the latter approach is highly preferable to the former from a cost and maintenance perspective, the wiring introduces a vulnerable point of failure in addition to potentially interfering with maintenance of the pressurized system.

According to various implementations enabled by the present disclosure, a component in a pressurized system may be monitored using a single monitoring device connected to either the inlet side or the outlet side of the component. Time-series data for the monitor (potentially both captured data and derived data) are used to define normal baseline operation (and potentially some range around normal) for any of a variety of pressurized system component types. Such definitions of normal are then used to detect deviations from the expected range. This might involve the identification of a general fault condition, but also could be refined to identify specific states and/or failure modes as represented by corresponding data signatures. Such signatures might be represented using data generated by one or multiple monitors, data at a given point in time, or data captured over a particular time range.

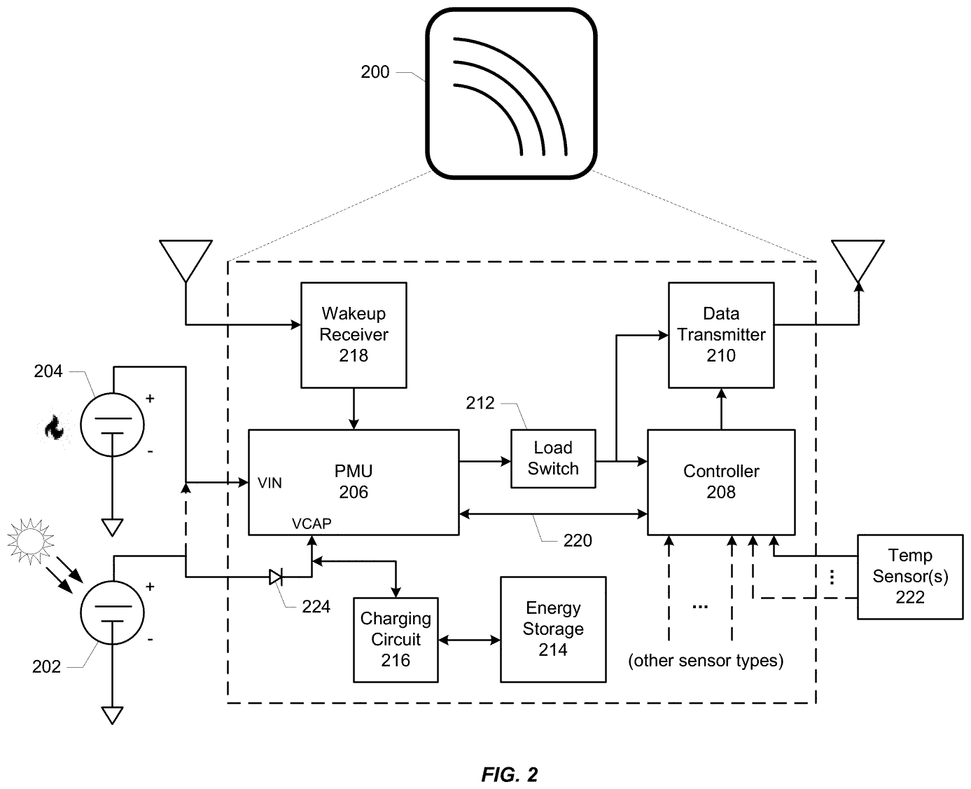

According to some implementations, monitors for components in a pressurized system are employed that operate using power harvested from the environments in which they are deployed. FIG. 2 is a block diagram of an example of such a monitor 200. In the depicted implementation, monitor 200 is powered using energy harvested from its environment with a photovoltaic (PV) device 202 that captures energy from the ambient light in the vicinity of monitor 200, and/or a thermoelectric generator (TEG) 204 that captures thermal energy from, for example, the pipes of the pressurized system. Implementations are contemplated in which the monitor's power management unit may be configured such that the monitor can use power from the PV device in a “solar only” mode (as indicated by the dashed line from PV device 202 to VIN), the TEG in a “TEG only” mode, or a combination of both in a “solar assist” mode (as indicated by the solid line from PV device 202 to VCAP). Suitable switching circuitry for configuring these connections will be known to those of skill in the art and so is not depicted for clarity.

Monitor 200 includes a power management unit (PMU) 206 that controls the delivery of power to controller 208 and data transmitter 210 via load switch 212. VIN is the harvesting input to PMU 206, and VCAP, and three voltage rails (not shown for clarity) are the generated outputs. PMU 206 charges energy storage device 214 (e.g., a super-capacitor) with VCAP via charging circuit 216 using energy harvested from either or both of PV device 202 and TEG 204 (depending on the harvesting mode). Load switch 212 and charging circuit 216 control when power is provided to the rest of monitor 200 and allow monitor 200 to be functional while energy storage device 214 is charging.

Monitor 200 receives a wakeup message (e.g., with wakeup receiver 218) from, for example, a system control node with which it is associated. Receipt of the wakeup message triggers control of load switch 212 by PMU 206 to provide power to controller 208 for capturing readings associated with the system component being monitored by monitor 200, and to transmitter 210 for transmitting sensor data to the control node. PMU 206 also communicates with controller 208 via digital I/O channel 220. This can be used by the controller to monitor the status of the PMU 206, and to update its configuration or calibration settings.

Once awakened and powered up, controller 208 captures readings using one or more sets of sensors associated with monitor 200. As depicted, these might include one or more temperature sensors 222 (e.g., a thermistor connected to the piping adjacent the inlet side or the outlet side of the component). Sensors to detect or measure other parameters or types of readings (e.g., ambient temperature and/or light, acoustic, ultrasonic, humidity, vibrational/mechanical energy, etc.) are also contemplated. As discussed above, controller 208 packetizes the digitized sensor data and transmits the packet(s) to the associated sensor node via data transmitter 210.

According to a particular implementation, PMU 206 includes a boost DC-DC converter that employs maximum power point tracking to boost the relatively low voltage VIN received from one of the harvesting sources (e.g., PV device 202 or TEG 204 depending on the mode) to a higher voltage VCAP at its output that is used to charge the energy storage device (e.g., 214). Once VCAP is sufficiently high, a buck/boost, a single-input-multiple-output (SIMO) DC-DC converter turns on and takes VCAP and brings it up or down (depending on the level of charge of energy storage device 214), generating three voltage rails; +2.5, +1.2, and +0.6 volts respectively. These voltage rails are for use in powering the other electronics of monitor 200 (e.g., controller 208 and transmitter 210).

In the “solar assist” harvesting mode, PV device 202 may be attached directly to VCAP through diode 224 (to prevent leakage) as represented by the solid line connection in FIG. 2. In this mode, and assuming its output is sufficient to forward bias diode 224, PV device 202 may provide a charging assist to TEG 204 with the energy of the two harvesting sources naturally combining in energy storage device 214 without requiring complicated control electronics. According to a particular implementation, in the “solar assist” mode, PV device 202 is used to raise VCAP such that the biasing to the boost converter turns on. This allows the boost to harvest from lower input voltages (e.g., allowing harvesting from lower temperature deltas on TEG 204). In another implementation, PV device 202 may connect to VIN of PMU 206 as shown by the dashed line in FIG. 2. This allows for lower levels of light, or lower voltage PV cells to be boosted to recharge the energy storage element.

More generally, implementations are enabled by the present disclosure in which energy may be harvested from multiple different energy sources and used in any combination to power such monitor. Other potential sources for harvesting include vibration energy (e.g., using a piezoelectric-based or a linear motion, electromagnetic-based device) and RF energy. As will be appreciated, these are AC energy sources and so would require AC-DC converters. And if the resulting DC voltages from any of these are not sufficiently high, they could be boosted using a boost converter.

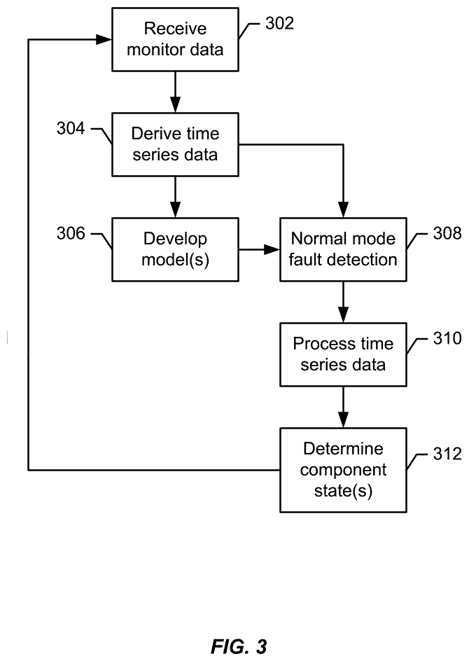

The processing of monitor data according to a particular class of implementations will now be described with reference to FIG. 3. As mentioned above, these processing techniques may be used in conjunction with monitors enabled by the present disclosure, but also may be used with any of a variety of other monitor types. The inputs to the processing algorithm may include time series data (e.g., in the form of one or more vectors) for the monitor representing the one or more captured temperatures, (optionally) ambient temperature, and time stamps for the corresponding values of the time series data. Such time series data represent the “continuous” monitoring that enables the modeling and detection of component state(s) as described herein.

The class of implementations depicted in FIG. 3 contemplates the use of monitors that only capture temperature readings for either the inlet side or the outlet side of the component being monitored. As implied elsewhere herein, this approach may have advantages in terms of cost and reliability relative to the use of monitors which capture both inlet and outlet temperature readings. However, as will be appreciated, it may still be possible to determine the state of a component as described herein using monitors that are configured to or are capable of capturing both inlet and outlet temperatures by ignoring the temperature data for the inlet or the outlet. The scope of the present disclosure should therefore not be limited to exclude such implementations.

In addition, the processing of monitor data for a particular monitor is depicted as including a training phase followed by an operation phase. These phases are shown as distinct for purposes of clarity. However, it will be understood that the phases may overlap in that, for example, training may continue during normal operation with captured data being used to update baseline models.

Referring now to FIG. 3, monitor data generated by a monitor mounted on or near a component in a pressurized system is received (302). The monitor data includes a set of temperature readings taken at the inlet or the outlet of the component being monitored and some kind of timing information (e.g., time stamps) that relates the temperature readings to each other and/or a system timeline. The monitor data may also include one or more additional sets of readings for various other parameters such as, for example, ambient temperature, humidity, vibration, etc. As mentioned above, in some cases the monitor data might even include one or more sets of temperature readings for the other side of the system component.

The timing of the readings may vary considerably as well. For example, in some pressurized systems and/or for some component types, it might be considered sufficient to generate readings about once a minute and be able to rely on such monitoring as being sufficiently “continuous” to capture relevant behavior. However, implementations are contemplated in which the time between readings might range from a few seconds to several minutes. In addition, the time between successive readings need not necessarily be uniform, allowing for considerable flexibility in how and when data are captured.

Time series data are derived from the monitor data (304). As mentioned above, the time series data may be in the form of one or more vectors in which the features values for each vector represent a reading at a given point in time. According to some implementations, each vector may include feature values for the monitor over its entire history, and each time the monitor data are processed, this entire history may be processed. Alternatively, implementations are contemplated in which only a subset of the monitor data for a given time range might be processed.

The time series data may include vectors representing the raw monitor data (e.g., outlet temperature, ambient temperature, time etc.), but also may include vectors representing derived data that might be useful for reliably determining particular component states. For example, a derived vector might include values that represent the time difference between consecutive samples in the time series data (e.g., as derived from the time input vector). Such information might be useful, for example, in determining the rate of change of any of the time series data.

In another example, derived vectors might represent envelopes for temperature data. For example, each envelope might be represented by two vectors including temperature values that are time-aligned to the original temperature values of the corresponding temperature vector. One of the envelope's vectors represents the maximum values of the corresponding temperature, while the other represents the minimum values. Such representations adapt slowly to changes in the underlying temperature and therefore might be useful for detecting when the temperature changes in unexpected ways.

In another example, a derived vector might include values that represent the difference between consecutive temperature samples. Such information might be useful, for example, in distinguishing between different component states and/or failure modes.

In another example, a derived vector might include values generated by feeding temperature readings through a DC blocking filter to generate a measure of the energy in the signal. Such a vector would be a representation of the stability of the corresponding temperature when they stable, and can be thought of as a kind of noise floor. Implementations are contemplated in which either the raw magnitude or the log of the raw magnitude of the temperature values are used. Again, this information may be useful in distinguishing between different component states and/or failure modes.

During a training phase, the time series data for the monitor are used to develop one or more baselines or models, each of which represents a particular state or fault condition for the pressurized system component being monitored (306). The nature of this training and the resulting model or baseline may vary considerably depending on the type of component and the number and/or types of component states being represented. In a simple example, the training phase might involve manual review of the range of inlet or outlet temperatures during normal operation by a human operator, in response to which the human operator might define a fault condition by setting a temperature threshold. During normal operation, a fault condition would be registered when the inlet or outlet temperature of the component being monitored crosses the defined threshold. For many applications and/or component types, such a monitoring approach will likely be sufficient to detect certain types of events, e.g., the rupture of a rupture disc.

In another example, the rate of change of the inlet or outlet temperature under normal conditions could be monitored (automatically or manually), and a fault condition defined (automatically or manually) in which thresholds are set for both the magnitude and the rate of change of the inlet or outlet temperature. Such an approach might be useful, for example, for applications in which relatively slower changes in temperature are expected as normal behavior, but rapid changes in temperature represent a fault or failure.

In another example, the temperature at the inlet or the outlet of a system component might be expected to vary considerably in complex but predictable ways as might be the case, for example, for a control valve. In such an application, the model or baseline for the normal behavior of the component could be developed using machine learning (ML) techniques to learn the behavior of the component using input vectors representing any of a variety of raw and derived data. A fault condition could then be any state that deviates sufficiently from the expected behavior represented by the model. Such an approach can also be used to learn to develop multiple models to support distinguishing different states of the component during normal operation and/or multiple states corresponding to multiple failure modes.

After the training phase, normal mode fault detection may proceed (308) in which the time series data (304) are processed with reference to the model or baseline (310) on an ongoing basis to determine the current state of the component being monitored (312). As will be understood, the training and normal operational modes may overlap and/or iterate in that information captured during normal operation may be used to update and evolve the model(s) or baseline(s) developed during training.

And as mentioned above, the nature of the model or baseline and the processing of the time series data may vary significantly depending on the type of component being monitored and/or the number of states to be detected. For example, for a rupture disc, the model or baseline might be a threshold against which the inlet or outlet temperature of the disc is compared. The assumption behind such a model or baseline is that, if the inlet or outlet temperature crosses the threshold, the disc must have ruptured (i.e., fully blown by); otherwise the disc will be considered to be intact.

On the other hand, it might be desirable to detect intermediate conditions for a rupture disc or a pressure relief value. That is, it is possible that such components might have slow or intermittent leakage of whatever medium is carried by the pressurized system. A simple threshold might not be sufficient to reliably capture such behavior. Therefore, the model or baseline could detect trends in the inlet or the outlet temperature over time that are indicative of such a condition.

And as will be appreciated, such a model or baseline might need to account for ambient temperature. That is, if the environment in which the component is deployed is characterized by significant changes in ambient temperature, it would be useful to be able to distinguish changes in the inlet or the outlet temperature from changes in the ambient temperature over the same period of time (e.g., by comparison of the behavior of the respective temperatures). More generally, ambient temperature may be integrated in a variety of ways with the models or baselines for any implementations enabled by the present disclosure to provide a more nuanced representation of the state(s) of the corresponding component.

In another example, monitoring the variance of the inlet or the outlet temperature over time can be used to detect relatively small changes in component behavior that may be worth further investigation. For example, if a control valve that cycles on and off has a slow and/or progressive leak, this can be detected even if the variance shows a change of only a few percentage points. Or, if a pressure reducing valve is configured to reduce pressure at the inlet side by a specific amount at the outlet side, even small deviations at the outlet side of the component may be detected.

More generally, for simple behaviors (e.g., intact vs. blown through rupture discs), the model or baseline used to detect the relatively few relevant states of a component may be straightforward and easily derived. For more complex behaviors (e.g., control valves or steam traps), the expected behavior, as well as the behavior for specific failure modes, may be learned in a training phase that generates corresponding models that account for various measured and derived data based on data received from the monitor at the inlet or the outlet of the component.

According to some implementations, a baseline for a given system component (e.g., for a good vs. bad state or for one or more failure modes) is established upon installation of the component in the system. This involves a training period, the length of which depends on the particular application. For example, if the application is such that a monitored parameter remains fairly constant, then the training period for that parameter can be relatively short. If, on the other hand, there is considerable variance for that parameter, then the training period may take longer. This training forms the baseline that is then used for comparison with subsequently captured monitor data to determine components state(s). As will be appreciated, such data may be acquired with some level of filtering to prevent false positives. As will also be appreciated, training may be conducted for each device monitored. However, it should be noted that implementations are contemplated in which the baseline for a particular component may be reinforced or replaced by equivalent data obtained for other components of the same type and/or deployed in the same or similar application.

According to some implementations, temperatures for a pressurized system component may be measured at multiple locations on the same side of the component. For example, multiple temperatures may be measured on the conduit connected to the component inlet or outlet at different distances along the conduit. This might be useful, for example, in differentiating between real failures and false-positive failures induced by nearby components. In another example, multiple temperatures may be measured at locations along the circumference of the conduit. The idea is that differences between these temperatures may be indicative of specific conditions or states of the component, and so may be used to learn how to detect such conditions or states. For example, measurements on the top and the bottom of a pipe can be used to detect two-phase flow in which a gas is on the top of the pipe and a liquid is on the bottom, e.g., as can be found in a steam system in which steam is the gas and condensate the liquid.

According to a particular implementation, two outlet temperatures are measured along the circumference of the inlet conduit or the outlet conduit; one at the top of the conduit and one at the bottom. This approach may be particularly useful, for example, in applications in which the material flowing through the conduit is actually two media, one of which is heavier than the other, e.g., a gas at the top and a liquid on the bottom. As will be appreciated, the two different media are likely to have different temperatures, particularly where they are two different phases of the same substance. Both the expected behavior and one or more failure modes may therefore be learned using this information as input. For example, the weighting of one phase versus another can be an indicator of not only a failure, but the severity of the failure. For example, if the output of a steam trap is almost entirely steam, then the trap failure is most likely a blow-through as no liquid has been allowed to build up. Conversely, if the output of the steam trap is primarily a liquid, this could indicate that the trap is inadequate for the application and is not discharging condensate fast enough.

More generally, implementations are contemplated in which the multiple points of monitoring on a conduit of a pressurized system are not necessarily associated with a particular or distinct system component apart from the conduit itself. That is, while such an approach may be used to infer or determine one or more states of a system component such as a safety valve or a rupture disc, it may also be used to infer or determine one or more states of the system including, for example, the presence or state of a medium or media within the conduit. For example, monitoring the temperature at the top and bottom of a conduit (e.g., around the circumference of the conduit) may yield time-series data from which the relative amounts of two different media within the conduit (e.g., steam and condensate) may be inferred or determined with reference to baselines or models developed as disclosed herein. In another example, monitoring temperatures spaced apart along the longitudinal axis of a conduit may yield time-series data representing temperature differentials that may be indicative of a particular state or states of the medium or media in the conduit, a portion or components of the system, and/or the system as a whole. In another example, multiple temperatures associated with a conduit having a particular shape (e.g., a bend in a conduit or a “U” trap) could represent a variety of conditions. More generally, a variety of system states may be inferred or determined from such time-series data based on corresponding baselines or models. The scope of the present disclosure should therefore not be limited by reference to specific implementations relating to particular types of system components, baselines or models, or particular component or system states.

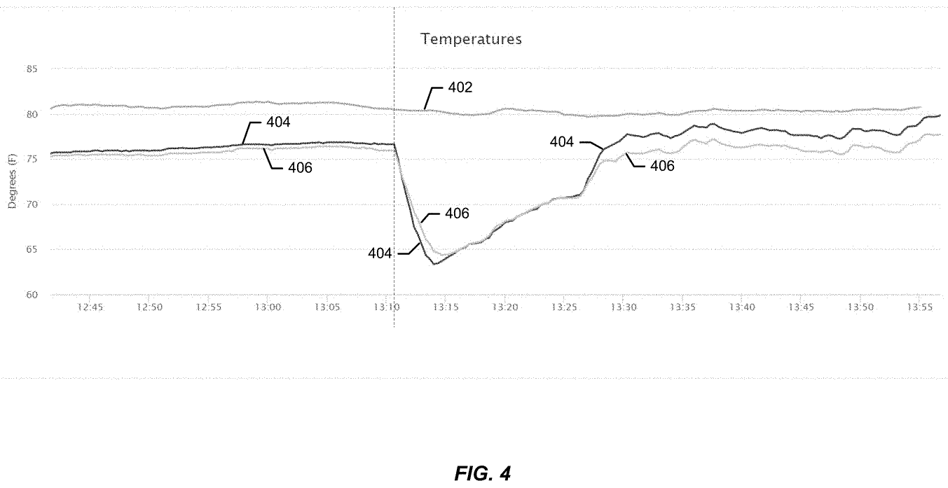

FIG. 4 is a graph of temperature vs. time illustrating the behavior of a safety valve in a 15 PSI compressed air system. Trace 402 represents the ambient temperature of the environment in which the system is deployed. Trace 404 represents the outlet temperature of the safety valve measured at the top of the outlet conduit. Trace 406 represents the outlet temperature of the safety valve measured at the bottom of the outlet conduit. Beginning at just after 13:10, temperature trace 404 records a temperature drop of about 13 degrees Fahrenheit and temperature trace 406 records a corresponding temperature drop of about 12 degrees Fahrenheit in about 4 minutes. Because this is a compressed air system, such a temperature drop would be expected for a safety valve release event. Therefore, based on the baseline model for the safety valve in this application, a notification of a release event would be generated.

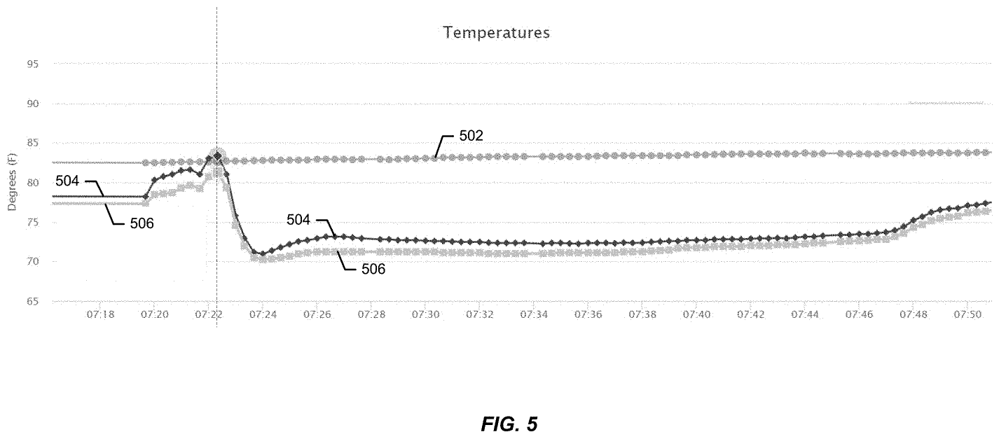

FIG. 5 is a graph of temperature vs. time illustrating the behavior of a safety valve in a 55 PSI compressed air system. Trace 502 represents the ambient temperature of the environment in which the system is deployed. Trace 504 represents the outlet temperature of the safety valve measured at the top of the outlet conduit. Trace 506 represents the outlet temperature of the safety valve measured at the bottom of the outlet conduit. Beginning at just after 7:22, temperature trace 504 records a temperature drop of about 12 degrees Fahrenheit and temperature trace 506 records a corresponding temperature drop of about 11 degrees Fahrenheit in less than 2 minutes. As would be expected in a higher pressure system (e.g., as compared to the system behavior depicted in FIG. 4, the temperature drop for a safety valve release would occur more quickly. Because this expected behavior is part of the baseline for this component in this application, the depicted temperature drop would again be the basis for generation of notification of a safety valve release event.

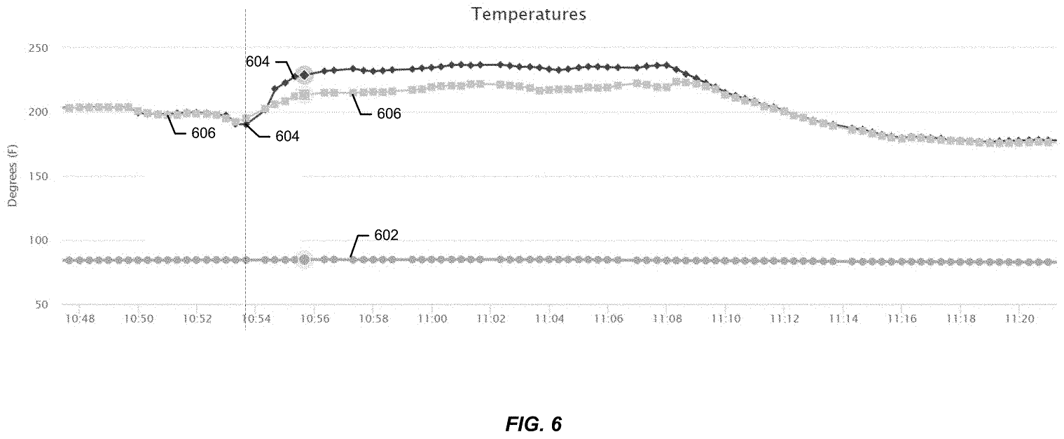

FIG. 6 is a graph of temperature vs. time illustrating the behavior of a safety in a 15 PSI steam system. Trace 602 represents the ambient temperature of the environment in which the system is deployed. Trace 604 represents the outlet temperature of the safety valve measured at the top of the outlet conduit. Trace 606 represents the outlet temperature of the safety valve measured at the bottom of the outlet conduit. Beginning at just before 10:54, temperature trace 604 records a temperature increase of more than 30 degrees Fahrenheit while temperature trace 606 records a temperature increase of only about 20 degrees Fahrenheit in about 2 minutes. As might be expected in a steam system, the temperature increase at the bottom of the outlet conduit is less than that at the top of the conduit due to the presence of the more dense and lower temperature condensate in the system. This behavior would be compared to the baseline for this configuration and would likely trigger a steam relief event.

As mentioned above, implementations are also contemplated in which system and/or component state may be determined based on temperature measurements associated only with the inlet of a system component. For example, a blow through failure of a steam trap in a steam system may be detected based on inlet temperature data alone. During normal operation, the pressure on the inlet of a stream trap (and therefore the temperature) is typically maintained at an expected level or within an expected range. If a blow through failure occurs, this reduces the pressure at the inlet, causing the temperature to drop. This drop and the corresponding failure can be detected based on monitoring of the inlet temperature alone.

In another example, a cold failure of a stream trap results in a temperature drop at the inlet of the trap due to the accumulation of condensate backing up and cooling the conduit as compared to the much hotter temperature of steam that is predominantly present during normal operating conditions. Again, this failure may be detected by monitoring inlet temperature alone.

Moreover, the ability to distinguish between different types of failures may be supported using inlet-only monitoring. For example, distinguishing between the blow through and cold failures described above may be accomplished though comparisons of the absolute temperature drop for each data set, as well as the rates of change for drops represented by the respective data sets.

As will be appreciated with reference to the foregoing examples, the techniques described herein may be adapted to model and monitor the behavior of a wide range of components in various types of pressurized systems.

It will also be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

1. A computer-implemented method, comprising:
receiving monitor data generated by a monitor associated with a component of a pressurized system, the component having an inlet and an outlet, the monitor being configured to capture measurements of a first temperature associated with one of the inlet of the component or the outlet of the component, but not to monitor a second temperature associated with the other of the inlet or the outlet of the component;
deriving first time series data from the monitor data, the first time series data representing the first temperature; and
determining a state of the component based on the first time series data and without reference to the second temperature.

2. The method of claim 1, wherein the first temperature corresponds to a first location along a circumference of a conduit connected to the one of the inlet or outlet of the component with which the first temperature is associated, and wherein the monitor is also configured to capture measurements of a third temperature associated with the one of the inlet or the outlet of the component with which the first temperature is associated, the third temperature corresponding to a second location along the circumference of the conduit and displaced from the first location, the method further comprising deriving second time series data from the monitor data, the second time series data representing the third temperature, and wherein the state of the component is also determined based on the second time series data.

3. The method of claim 2, wherein the second location is displaced from the first location along the circumference of the conduit by about 180 degrees.

4. The method of claim 2, wherein the first location is on a top of the conduit relative to a local gravity vector, and wherein the second location is on a bottom of the conduit relative to the local gravity vector.

5. The method of claim 1, wherein determining the state of the component based on the first time series data includes determining a rate of change of the first temperature based on the first time series data, and determining that the rate of change corresponds to the state of the component.

6. The method of claim 5, wherein the state of the component comprises an open state or a leaking state, and wherein determining that the rate of change corresponds to the state of the component includes determining that the rate of change corresponds to the open state or the leaking state.

7. The method of claim 1, wherein determining the state of the component based on the first time series data includes determining that first temperature exceeds a threshold.

8. The method of claim 7, wherein determining the state of the component based on the first time series data includes determining that first temperature exceeds the threshold within a first duration or for longer than a second duration.

9. The method of claim 1, wherein the monitor is also configured to capture measurements of an ambient temperature of the pressurized system in a vicinity of the component, the method further comprising deriving second time series data from the monitor data, the second time series data representing the ambient temperature, and wherein the state of the component is also determined based on the second time series data.

10. The method of claim 9, wherein the state of the component is determined based on the first time series data and the second time series data by comparing a change in the first temperature with a change in the ambient temperature.

11. A system, comprising one or more processors and memory configured to:
receive monitor data generated by a monitor associated with a component of a pressurized system, the component having an inlet and an outlet, the monitor being configured to capture measurements of a first temperature associated with one of the inlet of the component or the outlet of the component, but not to monitor a second temperature associated with the other of the inlet or the outlet of the component;
derive first time series data from the monitor data, the first time series data representing the first temperature; and
determine a state of the component based on the first time series data and without reference to the second temperature.

12. The system of claim 11, wherein the first temperature corresponds to a first location along a circumference of a conduit connected to the one of the inlet or the outlet of the component with which the first temperature is associated, and wherein the monitor is also configured to capture measurements of a third temperature associated with the one of the inlet or the outlet of the component with which the first temperature is associated, the third temperature corresponding to a second location along the circumference of the conduit and displaced from the first location, wherein the one or more processors and memory are further configured to derive second time series data from the monitor data, the second time series data representing the third temperature, and wherein the one or more processors and memory are configured to determine the state of the component based on the second time series data.

13. The system of claim 12, wherein the second location is displaced from the first location along the circumference of the conduit by about 180 degrees.

14. The system of claim 12, wherein the first location is on a top of the conduit relative to a local gravity vector, and wherein the second location is on a bottom of the conduit relative to the local gravity vector.

15. The system of claim 11, wherein the one or more processors and memory are configured to determine the state of the component based on the first time series data by determining a rate of change of the first temperature based on the first time series data, and determining that the rate of change corresponds to the state of the component.

16. The system of claim 15, wherein the state of the component comprises an open state or a leaking state, and wherein the one or more processors and memory are configured to determine that the rate of change corresponds to the state of the component by determining that the rate of change corresponds to the open state or the leaking state.

17. The system of claim 11, wherein the one or more processors and memory are configured to determine the state of the component based on the first time series data by determining that first temperature exceeds a threshold.

18. The system of claim 17, wherein the one or more processors and memory are configured to determine the state of the component based on the first time series data by determining that first temperature exceeds the threshold within a first duration or for longer than a second duration.

19. The system of claim 11, wherein the monitor is also configured to capture measurements of an ambient temperature of the pressurized system in a vicinity of the component, and wherein the one or more processors and memory are further configured to derive second time series data from the monitor data, the second time series data representing the ambient temperature, and wherein the one or more processors and memory are configured to determine the state of the component based on the second time series data.

20. The system of claim 19, wherein the one or more processors and memory are configured to determine the state of the component based on the first time series data and the second time series data by comparing a change in the first temperature with a change in the ambient temperature.

21-40. (canceled)
